(19) United States
(12) Patent Application Publication
(10) Pub. No.: US 2010/0093590 A1
(43) Pub. Date: Apr. 15, 2010

(54) Product and Process

(76) Inventor: Giovanni Zordan, Mira (IT)

Correspondence Address: PARFOMAK, ANDREW N.;NORRIS MCLAUGHLIN & MARCUS PA, 875 THIRD AVE, 8TH FLOOR, NEW YORK, NY, 10022, US

(21) Appl. No.: 12/447,263

(22) PCT Filed: Oct. 29, 2007
(86) PCT No.: PCT/GB07/04106

§ 371 Date: Dec. 14, 2009

(30) Foreign Application Priority Data
Oct. 31, 2006 (GB) 0621650.1

(51) Int. Cl. C11D 17/00

(52) U.S. Cl. 510/297

(57) ABSTRACT

A dye transfer inhibition product comprises a container containing a dye transfer inhibition composition. The container is formed by the closing of a sachet formed from a water permeable water insoluble web. The sachet comprises a flexible body of at least 10 mm in one dimension and 10 mm in another direction.

This invention relates to a dye transfer inhibition product, to a method for its preparation, and to its use in a washing method.

Dye transfer inhibition compositions have been available for some time. These compounds find use in laundry washing compositions to aid the prevention of dye transfer from one garment to another during a wash cycle.

Commonly the dye transfer inhibition composition is an integral part of the detergent formulation whether in liquid/powder form.

Whilst these compositions are of course extremely useful it can still be a problem for a user when there is a need to provide an enhanced level of dye transfer inhibition protection without simply adding more detergent formulation.

It is an object of the present invention to obviate/mitigate this disadvantage.

In accordance with a first aspect of the present invention there is provided a dye transfer inhibition product comprising a container containing a dye transfer inhibition composition, the container being formed by the closing of a sachet formed from a water permeable water insoluble web, characterised in that the sachet comprises a flexible body of at least 10 mm in one dimension and 10 mm in another direction.

It has been found that with the use of a sachet according to the invention great convenience is provided for a user as the right dosage of dye transfer inhibition composition is provided to the wash in an extremely convenient dosage form.

Preferably the body is such that no dimension is greater than 20 mm. Ideally each dimension is between 10-20 mm, e.g. 12 mm, 15 mm or 18 mm.

The sachet should not be able to move out of the drum, such as by entering the internal piping of the washing machine and onto the filter.

The flexibility of the body means it can deform on contact with fabric/clothing during a wash cycle so minimising damage to such fabric/clothing.

The body can also be compressed during packing so that smaller packs with less headspace can be utilised.

The body device may be configured to provide a volume adding function e.g. by being resilient so it expands on removal of compression forces. The inclusion of such a volume adding member has been shown to decrease the incidence of lodging of the device within the door seal, posting of the device in the door seal, facilitate the finding of the device after a washing operation, and can favour water flow through the device.

This in turn has a positive environmental impact by reducing the amount of packaging material required for each pack. When great numbers of packs are produced and sold, this has also positive influence on transport costs.

In a preferred embodiment the body comprises a foam material which may comprise any suitable material such as polypropylene, polyester and/or PE/EVA. The body may comprise a number of separate elements each being formed of a different material.

The product may comprise an indication means which serves to show the extent of performance of the dye transfer inhibition function. A preferred example of such an indication means is a colour change within the product. This colour change may occur on the sachet and/or on the body contained within the sachet. A preferred way of achieving the colour change is to use a colour catching compound which is attached to the sachet and/or to the body within the sachet.

We present as a subsequent feature of the invention a process for the preparation of a dye transfer inhibition product, the process comprising:
a) forming an open sachet from one, two or more water-permeable water-insoluble web;
b) filling the open sachet with a dye transfer inhibition composition; and
c) sealing the sachet.

### Optional Steps

Preferably the process includes the step of cutting the web(s) to form the open or closed sachet. Most preferably the process includes the step of cutting the closed sachet to form the dye transfer inhibition product.

A series of additional steps may be performed, in any order and combination; including:
a) distributing evenly the dye transfer inhibition composition through the sachet;
b) fixing the dye transfer inhibition composition to itself and/or the wall(s) of the sachet;
c) packaging the sachet into a moisture impermeable package.

We further present a method of inhibiting dye transfer within wash liquor comprising contacting wash liquor with a product as defined herein.

A method of inhibiting dye transfer may be a method used in a ware washing machine, for example a clothes washing machine. Preferably the product is able to work through the wash and the rinse cycle of the machine; or only in the rinse cycle, or just in the washing cycle.

Alternatively a method in accordance with the invention may be a manual method, for example using a hand-cloth or mop, and an open vessel, for example a bucket or bowl.

### Product Features

By water permeable we mean that the material allows water to pass through, under the conditions in which the product is used. Suitably the material has an air permeability of at least 1000 l/m²/s at 100 Pa according to DIN EN ISO 9237. In addition the web must not be so permeable that it is not able to hold a granular dye transfer inhibition composition (e.g. greater than 150 microns).

A closed sachet intended for use in a ware washing machine must resist a laundry wash cycle (2 h wash/rinse/spin cycle, 95° C., spinning at 1600 rpm) without opening.

Preferably the dye transfer inhibition composition is in the form of a granular composition. Preferably, the granular composition is spread across the interior of the sachet.

Preferably the granular composition is slightly tacky. In this way it has been found that premature release of the composition from the sachet (before us in a washing machine) is greatly mitigated.

A preferred way of forming such a cake is by the use of a granular dye transfer inhibition composition which includes a “tacky” component. A fragrance is a preferred example of such a component.

The product is preferably discarded after use.

The sachet is preferably flat, i.e. with one dimension, the thickness of the sachet, at least 5 times smaller preferably at least 10 times smaller, ideally at least 30 times smaller than the other two, the width and the length of the sachet (which are the same as each other, corresponding to the diameter of the sachet, should it be circular in plan). Preferred thickness are in the range of 10-20 mm, e.g. 10 mm, 15 mm or 20 mm.

Preferably the sachet covers a surface (i.e. the product of width and length (when the sachet is rectangular) of between 80 to 300 cm², ideally 100 to 200 cm². Preferred lengths/widths are in the range of 5-30 cm, e.g. 6 cm, 10 cm, 12 cm, 15 cm, 20 cm, 25 cm or 30 cm.

The sachet may be placed with the items to be washed in an automatic washing machine.

Alternatively the sachet may pack into the flow pathway for the rinse or wash water of a ware washing machine such that the water is compelled to flow through it.

### Dye Transfer Inhibition Composition

The water-softening composition may contain one or more dye transfer inhibition agents.

Any suitable dye transfer inhibition agent may be employed. Ideally the dye transfer inhibition agent is water soluble/dispersible in water. Unlike detergents or surfactants, which simply aid in the removal of soils from surfaces, the dye transfer inhibition agents actively binds to the dye allowing it to be removed from the surface of the laundry. Once bound, the dye is less likely to be able to redeposit onto the surface of the laundry. Preferred dye transfer inhibition agents have a high affinity to both oily and water-soluble dyes. Preferably, the dye transfer inhibition agent is a mixture of two or more dye transfer inhibition agents, each dye transfer inhibition agent may have a different affinity for different dyes.

Suitable dye transfer inhibition agents include polymers, such as acrylic polymers, polyesters and polyvinylpyrrolidone (PVP). The polymers may be crosslinked, examples of which include crosslinked acrylic polymers and crosslinked PVP. Super absorbing polymers are mainly acrylic polymers and they are useful for the scope of this patent.

Other important polymers are ethylidene norbene polymers, ethylidene norbene/ethylene copolymers, ethylidene norbene/propylene/ethylidene ter-polymers.

Inorganic materials may also be employed. Examples include silica, silicates (e.g. magnesium silicate), zeolites, talc, bentonites and active carbon. The latter may be used to absorb and/or degrade coloured parts of stain. Alginates, carrageneans and chitosan may also be used. Preferred water insoluble agents are selected from at least one of acrylic polymer, polyester, polyvinylpyrrolidone (PVP), silica, silicate, zeolite, talc, bentonites, active carbon, alginates, carrageneans, ethylidene morbene/propylene/ethylidene ter-polymers and chitosan in the manufacture of a cleaning composition as an active agent for binding soil. Preferably the cleaning composition is a laundry cleaning composition or stain-removing composition.

Preferably, the dye transfer inhibition agent comprises a solid cross-linked polyvinyl N-oxide, or chitosan product or ethylidene norbene/propylene/ethylidene ter-polymers or blend of the same, as discussed more fully hereafter.

Preferably the total amount of dye transfer inhibition composition is between 3 and 25 g, ideally between 3 and 10 g.

The composition is preferably substantially free of any surfactant and/or a source of active oxygen (whether water-soluble or not). In one embodiment the composition is preferably substantially free of phosphonate compounds, and more preferably is substantially free of any phosphorous-containing compounds. However other embodiments could contain one or more such compounds. By substantially free we mean less than 20% wt, 10% wt, 5% wt, less than 2% wt, less than 1% wt, ideally less than 0.5% wt of such compounds relative to the total weight of the dye transfer inhibition composition.

Preferably the dye transfer inhibition composition is of a powder form. By “powder” we mean any solid, flowable composition. Thus the powder may, for example, be in the form of granules or agglomerated particles. It may, however, be in the form of a loose agglomeration of particies. The d₅₀ particle size of the particles may range from 0.001 μm to 10 mm, preferably from 0.01 μm to 2 mm, and more preferably from 0.1 μm to 2 mm, for example 1 μm to 1 mm.

The composition generally includes a “filler”. Preferred fillers are inert and do not affect the dye transfer inhibition performance. A preferred filler is dextrose.

### Forming an Open Sachet

Sachet forming can be done in an horizontal or in a vertical plane, either from a single roll of water permeable water-insoluble material that is folded to form the walls of the sachet or from two or more rolls of water permeable water insoluble material that are joined together to form the walls of the sachet.

Machine assemblies for sachet forming, filling and sealing can be sourced from, VAI, IMA, Fuso for vertical machines; Volpack, Iman Pack for horizontal sachet machines; Rossi, Optima, Cloud for horizontal pod machines.

### Filling the Open Sachet

The open sachet is preferably configured as a pocket or pouch, preferably sealed or otherwise closed on three edges, and which can be filled through an edge, for example the fourth, open, side. The open sachet may preferably be formed by folding a single web and sealing it transversely to the fold at two spaced-apart positions, leaving one edge open.

Filling of the open sachet can be done with a variety of volumetric devices, such as a dosing screw or as a measuring cup. Typical dosing accuracy required at constant product density is +/−1% wt preferably, +/−5% wt minimum.

Filling devices are supplied by the companies mentioned above as part of the machine package.

Feedback control mechanisms acting on the speed of the dosing screw or on the volume of the measuring cup can be installed to maintain high dosing accuracy when the product density changes.

### Sealing

Seal strength is important, as the sachet must not open during the wash cycle or other type of cleaning or water-softening operation, otherwise any water insoluble ingredients might soil the items washed.

A seal strength of at least 5N/20 mm, preferably at least 10N/20 mm and most preferably at least 15N/20 mm according to test method ISO R-527 measured before the wash sealed sachet is subjected to a wash. The strength of any seal is very much dependent on the materials used and the conditions of the sealing process, for example the following conditions are used to generate good quality seals on 100% non woven polypropylene (PP) such as LS3440 by Freudenberg or Berotex PP 40 gsm by BBA or Axar A by Atex
heat sealing, preferably using flat sealing bars, 5 mm by 100 mm, Teflon coated stainless steel, typically 1 sec at 150° C.+/−1° C. at 20 kg/cm² actual sealing pressure, as achieved on a bench scale Kopp heat sealer and on the heat sealing devices of most of the machine suppliers mentioned before;
ultrasound sealing, preferably using grooved sealing bars, 5 mm by 150 mm, pattern with diagonal grooves at 45 degrees to the side of the seal, pitch of 15 mm and bar width of 5 mm with a nominal seal area coverage of 33%, 0.1 to 0.3 s at 20 kHz and 70 microns vibration amplitude, actual sealing pressure between 10 and 60 kg/cm², typical absorbed power 300 to 1200 W, typical absorbed energy 30 to 180 W, using ultrasound sealing equipment produced by companies like Mecasonic or Branson or Herrmann or Sonic or Dukane or Sonobond;
glue sealing, e.g. applying 10 g/m² of hot melt glue like Prodas 1400, PP, from Beardow Adams. Polyethylene (PE) or polyamides or polyurethanes or UV curable acrylics glues or epoxy resins can be used as well.

### Cutting the Closed Sachet

Cutting can be achieved through rotary knives, scissors, vibrating blunt knives and lasers.

### Distributing Evenly the Dye Transfer Inhibition Composition

Distribution of the dye transfer inhibition composition in the sachet can be achieved by the use of customised powder distribution devices based on a combination of vibrating belts and/or pressure rollers.

Typical sources of vibrations are electromagnetic orbital vibrators, rotating eccentric disks and crankshaft mechanisms. Suitable vibration frequencies are between 50 and 2000 Hz, preferably between 200 and 1000 Hz. Suitable vibration amplitudes are between 0.2 and 10 mm, preferably between 1 and 5 mm. Suitable residence times of the sachet between the belts or rollers are between 0.5 and 30 sec, preferably between 2 and 20 sec. Suitable pressures of the sachet between the belts or rollers are between 0.01 and 2 kg/cm², preferably between 0.2 and 1 kg/cm².

### Fixing the Dye Transfer Inhibition Composition

Preferably, this is achieved by heating the binder, when present, in the composition:
by convective heat, for example by the use of an hot air oven, typical residence times around 90 seconds for 130° C. air may be needed. Pressures of 0.01 to 1 kg/cm², preferably 0.05 to 0.3 kg/cm² facilitate the flow of the binder throughout the product mass;
by conductive heat, for example by the use of a heated pressure belt or belt to drum or drum to drum arrangement, typical residence times between 20 and 40 seconds for 130° C. heating elements, pressure on top of sachet of at least 100 g/cm², preferred 200 g/cm² may be applied also;
by IR heating or UV curing, for selective heating or polymerisation of specific binders, e.g. with 10-30 seconds under an IR radiation with a maximum emission at 2 microns wavelength.

It is possible to perform the step of distributing and fixing at the same time, for example, by the use of heated pressure rollers and/or belts.

A key feature for the selection of the binder, actives and sachet packaging is that:

T_{meiting}binder<T_{stability}actives and T_{melting}binder<T_{melting}sachet packaging

Cooling can be used and as is preferably achieved using dry/cool air (T<20° C., RH<50%) resulting in lower sachet temperatures, preferably below 30° C.

### Web Materials

Conventional materials used in tea bag manufacture or in the manufacture of sanitary or diaper products may be suitable, and the techniques used in making tea bags or sanitary products can be applied to make flexible products useful in this invention. Such techniques are described in WO 98/36128, U.S. Pat. No. 6,093,474, EP 0708628 and EP 380127A.

Conveniently the web is a non-woven. Processes for manufacturing non-woven fabrics can be grouped into four general categories leading to four main types of non-woven products, textile-related, paper-related, extrusion-polymer processing related and hybrid combinations

Textiles. Textile technologies include garnetting, carding, and aerodynamic forming of fibres into selectively oriented webs. Fabrics produced by these systems are referred to as drylaid nonwovens, and they carry terms such as garnetted, carded, and airlaid fabrics. Textile-based nonwoven fabrics, or fibre-network structures, are manufactured with machinery designed to manipulate textile fibres in the dry state. Also included in this category are structures formed with filament bundles or tow, and fabrics composed of staple fibres and stitching threads.

In general, textile-technology based processes provide maximum product versatility, since most textile fibres and bonding systems can be utilised.

Paper. Paper-based technologies include drylaid pulp and wetlaid (modified paper) systems designed to accommodate short synthetic fibres, as well as wood pulp fibres. Fabrics produced by these systems are referred to as drylaid pulp and wetlaid nonwovens. Paper-based nonwoven fabrics are manufactured with machinery designed to manipulate short fibres suspended in fluid.

Extrusions. Extrusions include spunbond, meltblown, and porous film systems. Fabrics produced by these systems are referred to individually as spunbonded, meltblown, and textured or apertured film nonwovens, or generically as polymer-laid nonwovens. Extrusion-based nonwovens are manufactured with machinery associated with polymer extrusion. In polymer-laid systems, fibre structures simultaneously are formed and manipulated.

Hybrids. Hybrids include fabric/sheet combining systems, combination systems, and composite systems. Combining systems employs lamination technology or at least one basic nonwoven web formation or consolidation technology to join two or more fabric substrates. Combination systems utilize at least one basic nonwoven web formation element to enhance at least one fabric substrate. Composite systems integrate two or more basic nonwoven web formation technologies to produce web structures. Hybrid processes combine technology advantages for specific applications.

The wall of the container may itself act as a further means for modifying the water, for example by having the capability of capturing undesired species in the water and/or releasing beneficial species. Thus, the wall material could be of a textile material with ion-capturing and/or ion-releasing properties, for example as described above, such a product may be desired by following the teaching of WO 02/18533 that describes suitable materials.

### Packaging

Preferably the product is held in a packaging system that provides a moisture barrier.

The packaging may be formed from a sheet of flexible material. Materials suitable for use as a flexible sheet include mono-layer, co-extruded or laminated films. Such films may comprise various components, such as poly-ethylene, poly-propylene, poly-styrene, poly-ethylene-terephtalate or metallic foils such as aluminium foils. Preferably, the packaging system is composed of a poly-ethylene and bi-oriented-poly-propylene co-extruded film with an MVTR of less than 30 g/day/m². The MVTR of the packaging system is preferably of less than 25 g/day/m²′ more preferably of less than 22 g/day/m². The film may have various thicknesses. The thickness should typically be between 10 and 150 μm, preferably between 15 and 120 μm, more preferably between 20 and 100 μm, even more preferably between 30 and 80 μm and most preferably between 40 and 70 μm.

Among the methods used to form the packaging over the container are the wrapping methods disclosed in WO92/20593, including flow wrapping or over wrapping. When using such processes, a longitudinal seal is provided, which may be a fin seal or an overlapping seal, after which a first end of the packaging system is closed with a first end seal, followed by closure of the second end with a second end seal. The packaging system may comprise re-closing means as described in WO92/20593. In particular, using a twist, a cold seal or an adhesive is particularly suited. Alternatively the packaging may be in the form of a sealable bag that may contain one or more (greater than ten but less than forty) sachets.

MVTR can be measured according to ASTM Method F372-99, being a standard test method for water vapour transfer rate of flexible barrier materials using an infrared detection technique.

In a preferred method of inhibiting dye transfer a product of the invention may be disposed in a clothes washing machine throughout the wash and rinse cycles, for example by being placed in the machine's drum with laundry to be washed.

In a further definition the invention may be stated to be a process for the preparation of a dye transfer inhibiting product, the process comprising
(a) folding a sheet of water-permeable water-insoluble sheet material;
(b) supplying a v composition to the folded sheet, the dye transfer inhibiting composition comprising at least one dye transfer inhibiting agent and a fusible binder;
(c) sealing the open sides of the sheet to form an enclosure containing the dye transfer inhibiting composition;
(d) supplying heat to the enclosures to fuse the binder, and cooling it to form a “cake” of dye transfer inhibiting composition spread across the inside of the interior of the enclosure; and
(e) cutting the sheet or enclosure to form a sachet, the cutting being carried out at any suitable stage of the process.

In a further definition the invention may be stated to be a dye transfer inhibiting product formed by a process as described in the previous paragraph, wherein the sachet is of size in the range 80 to 300 cm², and contains at least 3 g of dye transfer inhibiting composition, and wherein the cake breaks in use creating loose granular insoluble materials that can move freely inside the sachet.

A product may be disposed in a clothes washing machine throughout the wash and rinse cycles, for example by being placed in the machine's drum with laundry to be washed.

In this specification percentage values, indicated by the symbols % or % wt, denote weight of the stated component expressed as a percentage of the total composition weight unless otherwise stated.

The invention will now be described, by way of embodiment, with reference to the following example.

### EXAMPLE 1

A formulation was prepared as below.

| Component | Weight % |
|---|---|
| PVP | 5.00 |
| PEG 6000 | 23.10 |
| Dextrose Monohydrate | 70.00 |
| Zeolite | 1.00 |
| Silica | 0.1 |
| PEG 400 | 0.5 |
| perfume Green Tea | 0.3 |

This formulation was added into a 12 cm×12 cm sachet of water insoluble web material.

When used in a washing process the product showed excellent dye transfer inhibition performance.

1. A dye transfer inhibition product comprising a container containing a dye transfer inhibition composition, the container being formed by the closing of a sachet formed from a water permeable water insoluble web, wherein the sachet comprises a flexible body of at least 10 mm in one dimension and 10 mm in another direction.

2. A product according to claim 1, wherein the body comprises polypropylene, polyester, or PE/EVA.

3. A product according to claim 1 wherein the body comprises a number of separate elements each being formed of a different material.

4. A product according to claim 1, wherein the product comprises an indication means which serves to show the extent of performance of the dye transfer inhibition function.

5. A process for the preparation of a product according to claim 1, the process comprising the steps of:
forming an open sachet from one, two or more water-permeable water-insoluble web;
filling the open sachet with a dye transfer inhibition composition; and
sealing the sachet.

6. A process according to claim 5, wherein the process includes the step of cutting the web(s) to form the open or closed sachet.

7. A method of inhibiting dye transfer in wash liquor water comprising the steps of:
providing a product according to claim 1 to the wash liquor water.

8. A method according to claim 7 wherein the wash liquor water is present in a ware washing machine.
